(19) United States
(12) Patent Application Publication
(10) Pub. No.: US 2008/0137787 A1
(43) Pub. Date: Jun. 12, 2008

(54) Method and apparatus to overcome harmonic interference

(76) Inventor: Menashe Soffer, Katzir (IL)

Correspondence Address: PEARL COHEN ZEDEK LATZER, LLP, 1500 BROADWAY, 12TH FLOOR, NEW YORK, NY, 10036, US

(21) Appl. No.: 11/637,243

(22) Filed: Dec. 12, 2006

(51) Int. Cl. H04B 1/10

(52) U.S. Cl. 375/346

(57) ABSTRACT

A computing platform and method of controlling interference caused by a clock of the computing platform is provided. The method includes, locating a band of frequencies of a wireless communication device which interfered by one or more harmonics of the clock frequency of the computing platform and modulating the clock frequency according to a frequency modulating pattern. The frequency modulating pattern excludes modulation of clock frequencies which their harmonics cause interference to the wireless communication device.

### BACKGROUND OF THE INVENTION

Bus clocks of computer system platform may become a source of interference noise. The interference caused by the bus clocks may severely degrade the performance of components and/or devices of the computer system platform. For example, in notebook platforms an antenna may be placed on a lid of the notebook platform. This may cause interference to an operation of a liquid crystal display (LCD) of the notebook platform.

In order to avoid some noise interference effects, the computer platform has to meet at least some Electro Magnetic Compatibility (EMC) requirements. To meet the EMC requirements, frequency modulating (FM) of the bus clock may be used to spread an interfered spectrum. The FM may include a modulation depth of 0.5% (e.g., periodically shifting the bus clock frequency between nominal minus 0.5% to nominal plus 0.5%). By providing FM to the bus clock, the average clock rate remains intact however; the interference at spectral power density of all the harmonics of the bus clock frequency may be reduced.

The FM may solved EMC issues, however this technique is not always sufficient to solve the EMC issues for communication devices because the communication channel includes the complete spread clock harmonics.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a block diagram of a computing platform according to exemplary embodiments of the invention;

FIG. 2 is a graphic presentation of a FM pattern according to exemplary embodiments of the invention; and

FIG. 3 is a flowchart of a method to control interference of a clock of a computing platform according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as platforms which include, but not limited to, a central processing unit, one or more buses, a clock bus, one or more memory, on or more video controller, one or more audio controller, one or more display controller, one or more wireless communication devices or the like.

Turning first to FIG. 1 a schematic illustration of a block diagram of a computing platform 100 according to exemplary embodiments of the invention is shown. Although the scope of the present invention is not limited in this respect, computing platform 100 may include a clock 110, an FM modulator 120, a wireless local area network (WLAN) device 130, a Global Positioning System (GPS) receiver 140, an interference controller 150, a bus 180 and antennas 160 and 165.

According to one exemplary embodiment of the invention, a bus 180 may transfer data, commands and clock 110 to components and devices of computing platform 100. A clock rate of clock 110 may be, for example 14.318 MHz. The clock rate may generate harmonics 170 and/or 175. The harmonics 170 and 175 may be received by antenna 160 of GPS receiver 140 and/or by antenna 165 of WLAN device 130, respectively. For example, GPS receiver 140 may be tuned to GPS L1 band. In at least some GPS receivers, L1 band frequency is 1575.42 MHz+/−1 MHz. The 110^{th} harmonic of clock 110 may be 1574.98 MHz which is within the GPS L1 band. For example, assuming 0.5% FM of clock 110, the harmonics of clock 110 may vary between 1566.55 MHz and 1582.85 MHz, although it should be understood that the scope of the present is not limited to this example.

In some exemplary embodiments of the present invention, a power of the 110^{th} harmonic of clock 110 may be −90 dBm. Thus, the 110^{th} harmonic may cause interference to a reception of a GPS signal. Interference controller 150 may include, for example, a table of one or more clock harmonics that may cause interference to devices of computing platform 110 (e.g., GPS receiver 140 and/or WLAN device 130). Furthermore, interference controller 150 may receive indication on an operation mode of devices of computing platform 110.

According to some exemplary embodiments of the present invention, interference controller 150 may control a modulation pattern of FM modulator 120. The modulation pattern is designed to remove harmonics that cause interference to an operating device of computing platform 110.

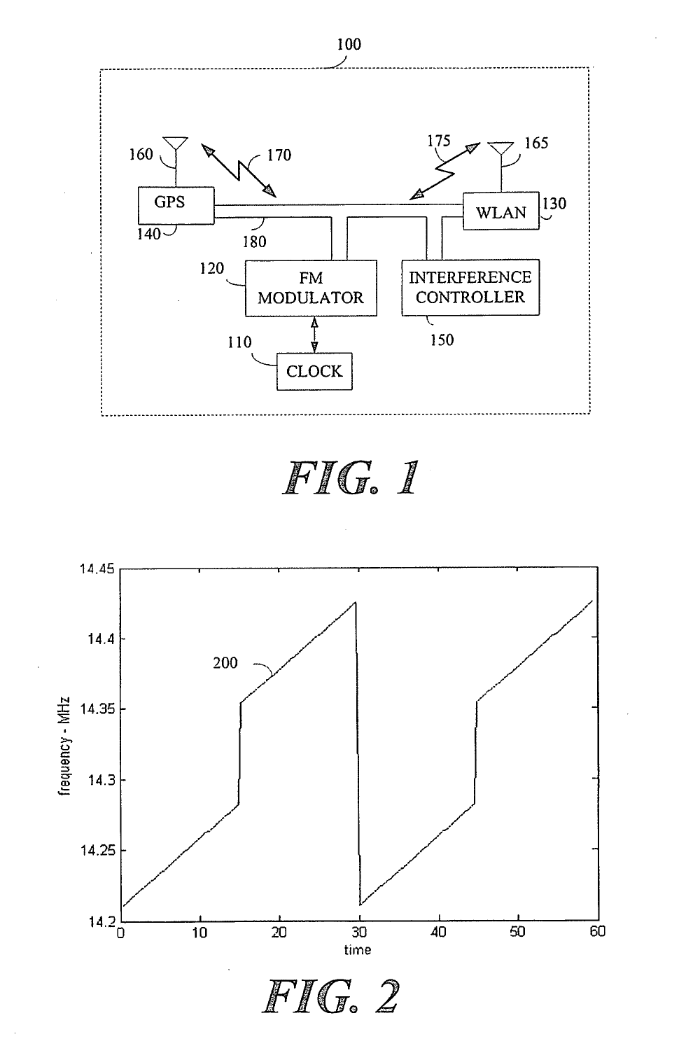

Turning to FIG. 2, a graphic presentation of a FM pattern 200 according to exemplary embodiments of the invention is shown. Although the scope of the present invention is not limited to this exemplary FM pattern 200, a prevailing FM modulation may be represented as a ‘saw-tooth’ pattern representing frequency verses (vs.) time. In order to remove the interference without changing the average clock rate, “ramp & saw-tooth” modulation pattern (e.g., FM pattern 200) is provided by interference controller 150 to FM modulator 120, if desired. For example, interference controller 150 may exclude the harmonics that cause interference by controlling the “ramp” depth. According to this example, FM modulator 120 may sweep clock 110 between 14.21 MHz and 14.28 MHz for a first half of the time and to sweep clock 110 from 14.35 MHz to 14.43 MHz for a second half of the time. According to this example, the 110^{th} harmonic (e.g., range 1571.05 MHz to 161.4 MHz), 109^{th} harmonic (e.g., 1572.4 MHz) and the 111^{th} harmonic (e.g., 1577.3 MHz) are cleared.

It should be understood that the above pattern is an example only and other patterns may be used according to parameters that may have effect on the EMC of computing device 100. For example, frequency range, power of harmonics, and the like.

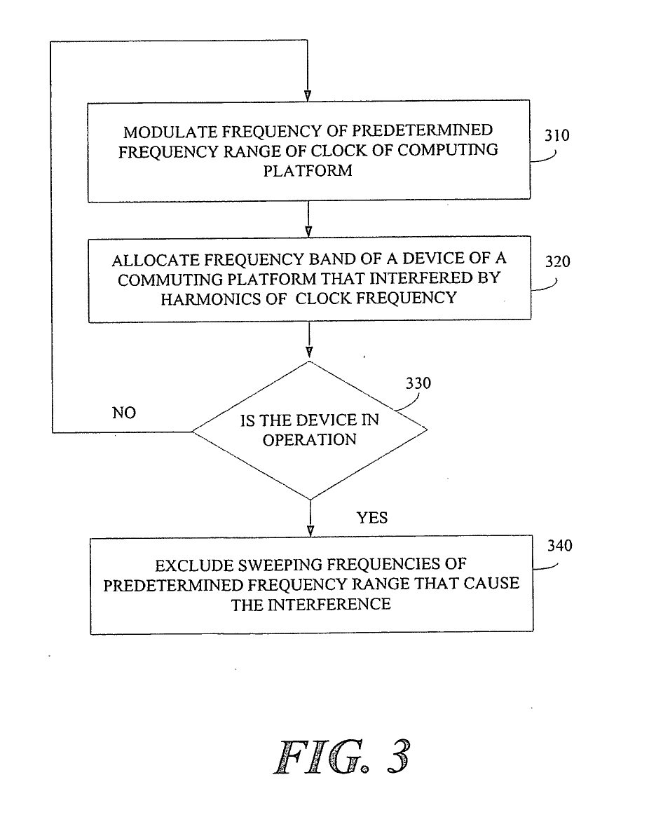

Turning to FIG. 3, a flowchart of a method to control interference of a clock of a computing platform according to exemplary embodiments of the invention is shown. Although the scope of the present invention is not limited to this exemplary method, a frequency modulating of a predetermined frequency of a clock (e.g., clock 110) of a computing platform (e.g., computing platform 100) is provided (text block 310). For example, interference controller 150 may allocate a frequency band of a device (e.g., GPS receiver 140) that may be interfered by one or more harmonics of the computing platform clock (text block 320).

According to one exemplary embodiment of the invention, interference controller 150 may sense an operation state of the device that might be effected by the interference (diamond 330) and may exclude sweeping clock frequencies that may cause the interference to the device which is in operation (text block 340).

Although the scope of the present invention is not limited in this respect, it should be understood that components of the present invention may be implemented by hardware, by software and/or any combination of hardware and software.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
locating a band of frequencies of a wireless communication device of a computing platform which interfered by one or more harmonics of a clock frequency of the computing platform; and
modulating the clock frequency according to a frequency modulating pattern, wherein the frequency modulating pattern exclude clock frequencies which their one or more harmonics cause interference to the wireless communication device.

2. The method of claim 1, comprising:
generating the frequency modulating pattern based on harmonics of the clock and the band of frequencies.

3. The method of claim 1, comprising:
sensing an operation of the wireless communication device; and
controlling a level of interference to the wireless communication device according to the frequency modulating pattern.

4. The method of claim 3, comprising:
modulating the clock frequency with another frequency modulating pattern when the wireless communication device is not operating.

5. A computing platform comprising:
a clock to provide a clock frequency to a bus of the computing platform;
a wireless communication device operably coupled to the bus;
an interference controller to locate a band of frequencies of the wireless communication device which interfered by one or more harmonics of the clock frequency; and
a frequency modulator to modulate the clock frequency according to a frequency modulating pattern, wherein the frequency modulating pattern exclude clock frequencies which their one or more harmonics cause interference to wireless communication device.

6. The computing platform of claim 5, wherein the interference controller is able to generate the frequency modulating pattern based on harmonics of the clock and the band of frequencies.

7. The computing platform of claim 5, wherein the interference controller is able to sense an operation of the wireless communication device; and
controlling a level of interference to the wireless communication device according to the frequency modulating pattern.

8. The computing platform of claim 5, wherein the interference controller is able to control the frequency modulator to modulate the clock frequency with another frequency modulating pattern when the wireless communication device is not in operation.

9. The computing platform of claim 5, wherein the wireless communication device comprises a Global Positioning System (GPS).

10. The computing platform of claim 9, wherein the GPS receiver comprise an antenna to receive the harmonics of the clock.

11. The computing platform of claim 5 comprising a laptop computer.

12. The computing platform of claim 10 wherein the antenna is operably coupled to a display of a laptop computer.

13. A computing platform comprising:
a clock to provide a clock frequency to a bus of the computing platform;
a Global Positioning System (GPS) receiver operably coupled to the bus;
an interference controller to locate a band of frequencies of the GPS receiver which interfered by one or more harmonics of the clock frequency; and
a frequency modulator to modulate the clock frequency according to a frequency modulating pattern, wherein the frequency modulating pattern exclude clock frequencies which their one or more harmonics cause interference to GPS receiver.

14. The computing platform of claim 13, wherein the interference controller is able to generate the frequency modulating pattern based on harmonics of the clock and the band of frequencies.

15. The computing platform of claim 13, wherein the interference controller is able to sense an operation of the wireless communication device; and
controlling a level of interference to the GPS receiver according to the frequency modulating pattern.

16. The computing platform of claim 13, wherein the interference controller is able to control the frequency modulator to modulate the clock frequency with another frequency modulating pattern when the GPS receiver is not in operation.

17. The computing platform of claim 13, wherein the GPS receiver comprise an antenna to receive the harmonics of the clock.

18. The computing platform of claim 13 comprising a laptop computer.

19. The computing platform of claim 17, wherein the antenna is operably coupled to a display of a laptop computer.
